(19) United States
(12) Patent Application Publication
(10) Pub. No.: US 2004/0026867 A1
(43) Pub. Date: Feb. 12, 2004

(54) Bearing seal

(76) Inventors: David J. Adams, North Canton, OH (US); Gerald P. Fox, Massillon, OH (US); Richard Borowski, Canton, OH (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/215,445

(22) Filed: Aug. 9, 2002

(51) Int. Cl. F16J 15/54

(52) U.S. Cl. 277/349

(57) ABSTRACT

A two-piece seal is provided for a bearing assembly. The seal includes a first seal ring or labyrinth element received on an inner diameter of the bearing outer race and a second seal ring or labyrinth received on an outer diameter of the bearing inner race. The labyrinth include ribs and channels on facing or opposed surfaces which are sized and shaped such that the rib of one seal ring is received in the groove of the opposing seal ring to thereby form a labyrinth path between the two labyrinth elements. Additionally, a flexible seal lip is formed on one of the labyrinth elements to form a dynamic seal between the two labyrinth elements at an inner end of the labyrinth path.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to seals, and, in particular, to a seal for use with bearings, for example, large diameter bearings such as are used on the main shafts of wind turbines.

Due to the nature of the application, servicing or replacing bearings or seals on large diameter bearings, such as used on the main shaft of a wind turbine, can be physically difficult and expensive. The seal on the outer row is especially difficult to replace, inasmuch as it entails removal of the propeller blades of the turbine. Any-servicing of the bearing would require the turbine to be shut down, with the resultant loss of revenue due to the down time of the turbine. To avoid this, the bearing and outboard seal are typically required to last the life of the turbine, which is generally considered to be twenty (20) years. Replacement of the seal on the inboard side is possible, if deemed necessary.

Current sealed bearings used in, for example, wind turbines, incorporate traditional garter spring loaded single lip seals. The performance of this type of seal has proved unsatisfactory over the long term due to wear of the sealing lip, which eventually allows ingress of water and contaminants into the bearing and leakage of grease from the bearing. Most wind turbines incorporate an automatic regreasing system to replenish the lubricant within the bearing. The bearing seals are therefore required to withstand the increase in pressure caused during regreasing and effectively seal the bearing such that excess grease is directed towards the grease outlet holes in the bearing outer race and not allowed past the seal lip to the external environment.

### BRIEF SUMMARY OF THE INVENTION

A seal is provided for a bearing assembly. As is known, a bearing assembly includes an outer race, an inner race, a plurality of rolling elements positioned between the inner and outer races, and a cage to space the rolling elements apart. Although the seal of the invention is shown used with a tapered roller bearing, it will be appreciated that the seal is applicable to other types of bearings as well. It will also be appreciated that the seal of the present invention has applicability in other environments in which a rotatable shaft is received in a housing and it is desirable to seal the connection between the shaft and the housing to prevent loss of lubricant.

The seal is a two piece seal which includes a first seal ring received on an inner diameter of a first part and a second seal ring received on an outer diameter of a second part. The two parts are rotatable relative to each other, with one part being received in the other part. The two parts are separated by a layer of lubricant. In the illustrative embodiments described below, the first seal ring is a first labyrinth element and the second seal ring is a second labyrinth element. Additionally, the first labyrinth element is located axially closest to the lubrication it seals and the second labyrinth element is located axially furthest from the lubrication is seals.

The first labyrinth element (the first seal ring in the preferred embodiment) has an axial outer surface that faces the second labyrinth element and has at least one channel and at least one rib in its axial outer surface. The first labyrinth element has a circumferential wall having a radial inner surface which is at least partially sloped, such that the axial outer end of the surface is narrower than the axial inner end of the surface. A flexible lip is formed at the radial inner end of the first labyrinth element. Several pumping cavities can be formed on an axial inner surface of the seal lip.

The second labyrinth element has an axial inner surface that faces the first labyrinth element with at least one channel and at least one rib on its axial inner surface. It also includes a radial outer surface that is at least partially sloped, such that the axial outer end of the radial outer surface is smaller in diameter than the axial inner end of the radial outer surface.

The ribs and channels of the first and second labyrinth elements are positioned such that the rib of one labyrinth element is received in the channel of the other labyrinth element, and vice versa to define a labyrinth path between the two labyrinth elements. The sloped surfaces are positioned on the first and second labyrinth elements to be opposite each other with the sloped surface of the second labyrinth element at a smaller diameter than the sloped surface of the first labyrinth element. The seal lip on the first labyrinth element engages the second labyrinth element at a diameter smaller than the inner most end of the labyrinth path. The seal lip can engage either an axial extending surface of the second labyrinth element or a radial extending surface of the second labyrinth element. When the seal is positioned in a bearing assembly, the labyrinth elements form static seals with the inner and outer races of the bearing assembly. If the seal is used in conjunction with an assembly other than a bearing, the labyrinth elements will form static seals with the two parts of the assembly (i.e., a shaft rotatably received in a housing). Additionally, the seal lip forms a dynamic fluid barrier between the two labyrinth elements.

### BRIEF DESCRIPTION OF THE SEVERAL VIEWS OF THE DRAWINGS

FIG. 1 is a cross-sectional view of a seal of the present invention incorporated in a bearing;

FIG. 2 is an enlarged cross-sectional view of the seal taken along line 2-2 of FIG. 1;

FIGS. 3A and 3B are cross-sectional and plan views showing a clamping plate used in conjunction with seal;

FIG. 4 is a cross-sectional view of a first labyrinth element of the seal showing pumping cavities of the seal; and

FIG. 5 is a cross-sectional view of a second illustrative embodiment of the seal applied to a bearing.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes adaptations, variations, alternatives and uses of the invention, including what we presently believe to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

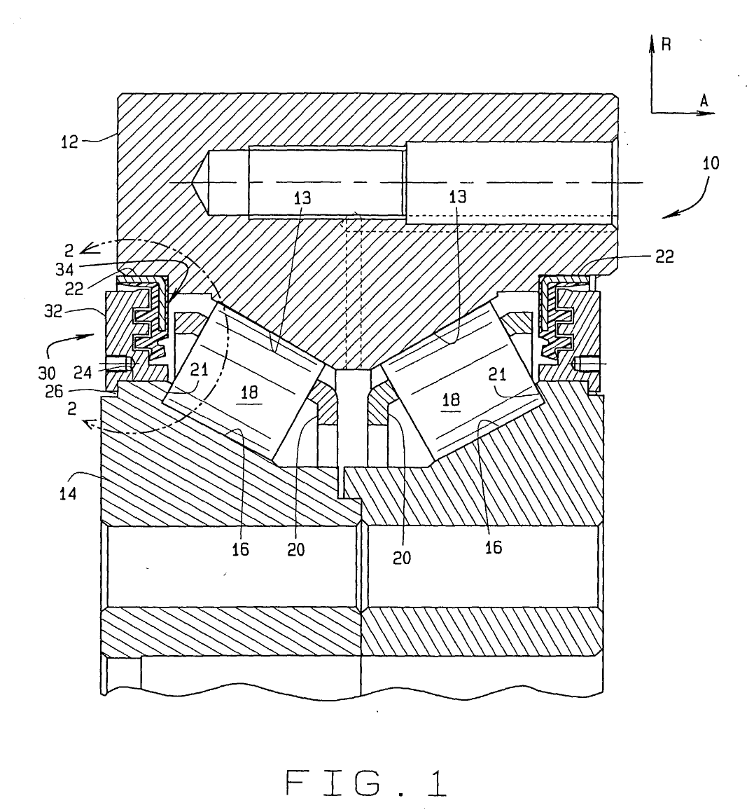

As seen in FIG. 1, a bearing 10 includes an outer race or cup 12 having an outer raceway 13 and an inner race or cone 14 having an inner raceway 16. A plurality of rolling elements 18 are positioned between the inner raceway 16 and the outer raceway 13, and are spaced apart by cages 20. The outer race 12 includes a bore 22 located at a diameter larger than the large end of the raceway 13. A thrust rib 21 is formed on the inner race 14 to be engaged by the axial larger end of the rolling element 18. The thrust rib 21 has an outer diameter surface 24. A radial groove is formed at the axial outer end of the thrust rib and forms a shoulder 26. In the instant case, the bearing assembly is shown to be a tapered roller bearing assembly, and the rolling elements are tapered rollers. However, it will be appreciated that the invention is applicable to other types of bearing assemblies which use other forms of rolling elements and more broadly to applications which incorporate a two parts that rotate with a relative speed to each other.

In the description below, reference is made to axial and radial directions. The axial direction is shown by the arrow A and the radial direction is shown by the arrow R. Hence, the bearing 10 rotates in a plane perpendicular to the paper about an axis which is parallel to the arrow A. Radially outward means away from the axis of the bearing 10 and toward the circumferential outer edge of the cup 12. Axially outward is defined as the direction from the fluid retained by the seal towards the environment the fluid is being separated from. Thus, for example, in FIG. 1, the “axially outward” direction is generally parallel to the axis of the bearing and is from the center of the bearing towards the end faces of the bearing. It is also the direction from the first labyrinth element 34 to the second labyrinth element 32 of the seal 30.

The bearing 10 is provided with a seal 30 which seals the space between bore 22 of the outer race 12 and the outer diameter surface 24 of the inner race 14 to substantially prevent contaminants from reaching the rolling elements 18 and to substantially prevent the escape of lubricant from the bearing. The seal 30 includes first labyrinth element 34 which is pressed onto the bore 22 of the outer race 12 and a second labyrinth element 32 which is press fit on the outer diameter surface 24 of the inner race 14. As described below, the first and second labyrinth elements 34 and 32 form a labyrinth seal or path therebetween and seal against each other. As seen, the second labyrinth element 32 is an axial outer ring, and the first labyrinth element is an axial inner ring, however, it will be appreciated from the description below, that the orientation can be reversed.

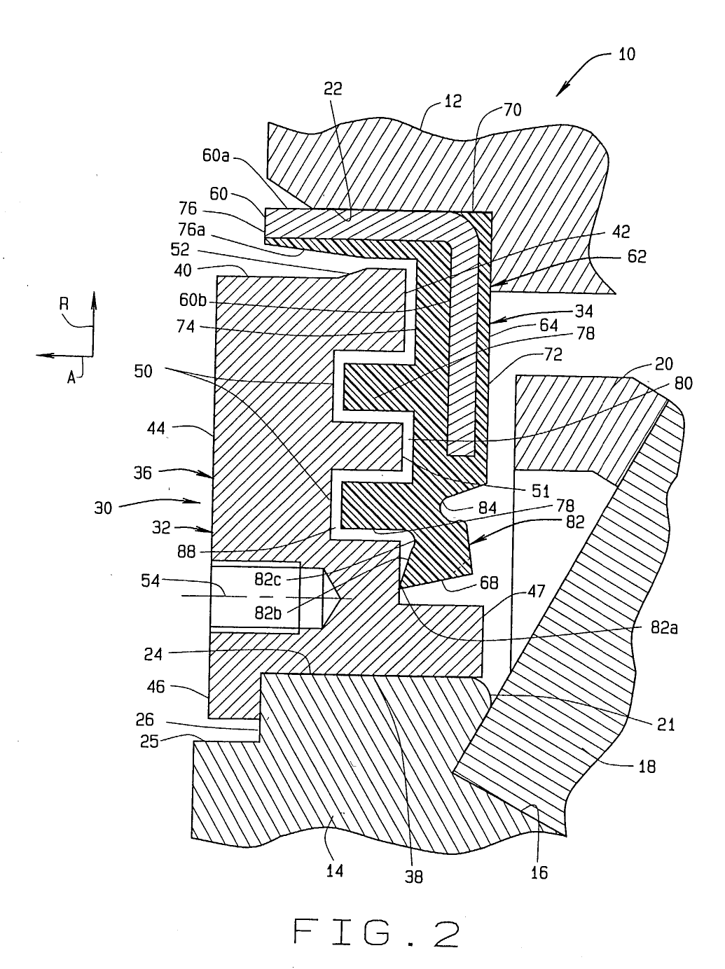

Turning to FIG. 2, the second labyrinth element 32 includes a radial inner surface 38, a radial outer surface 40, an axial inner surface 42, and an axial outer surface 44. A flange 46 extends radially inwardly from the radial inner surface 38 at the axial outer surface 44. The flange 46 is flush with the axial outer surface 44 and is effectively a continuation thereof. Additionally, a circumferential rim or wall 47 extends axially inwardly from the axial inner surface 42 at the radial inner surface 38. Hence, the wall 47 is a continuation of the radial inner surface 38. As seen in FIG. 2, the inner diameter of the second labyrinth element 32 at the radial inner surface 38 is sized to be received on the outer diameter surface 24 of the inner race, and the ring flange 46 engages the inner race shoulder 26. The wall 47 extends sufficiently from the ring axially inner surface 42 such that the ring engages substantially the full length of the cone outer diameter surface 24. A pair of axially extending grooves 50 are formed in the axial inner surface 42 of the labyrinth element 32. The grooves 50 define an axially extending ring or rib 51 therebetween. The radial outer surface 40 is sloped, as at 52, such that the outer diameter of the labyrinth element 32 at the axial inner surface 42 is greater than the outer diameter of the labyrinth element 32 at the axial outer surface 44. Lastly, the second labyrinth element 32 includes threaded holes 54 to facilitate removal of the seal during servicing, if required.

The first labyrinth element 34 incorporates a metal case 60 which is generally L-shaped and has an axially extending leg 60a and a radial extending leg 60b. The case 60 supports a sealing element 62 which is made from an elastomeric material. The elastomeric sealing element 62 encases or surrounds the radial extending leg 60b of the case 60 and covers the radial inner face of the case axial leg 60a.

The first labyrinth element 34 has a cylindrical, annular base 64 having a radial inner surface 68, a radial outer surface 70, an axial inner surface 72, and an axial outer surface 74. The radial outer surface 70 is defined by the outer surface of the case axial leg 60a. A circumferential wall or rib 76, extends axially outwardly of the axial outer surface 74 of the base 64. As can be seen, the case axial leg 60a forms part of the wall 76 and defines the radial outer surface of the wall 76. The outer diameter of the wall 76 (and hence, the outer diameter of the first labyrinth element 34) is sized to be press fit in the bore 22 of the outer race 12. The radial inner surface of the wall 76 is sloped as at 76a, such that the thickness or width of the wall 76 narrows towards its axial outer end. A pair of ribs 78 extend axially outwardly from the base outer surface 74 and form a channel 80 therebetween. The radial outermost rib 78 is spaced radially inwardly from the circumferential wall 76.

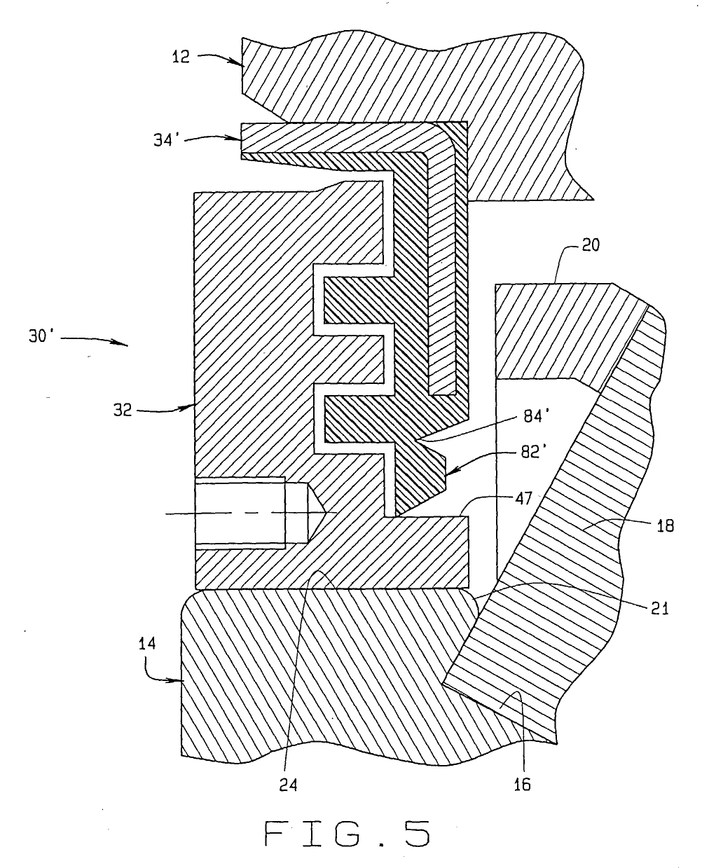

A seal lip 82 defines the radial inner portion of the base 64. The radial inner surface of the radial inner rib 78 is approximately flush with the radial outer edge of the lip 82. As seen, the lip 82 is shown to be generally trapezoidal in shape, and comes to a point 82a at its radial inner and axial outer end. It includes a sloped surface 82b which extends from the point 82a toward a curved junction 82c between the lip 82 and the radial outer rib 78. On its axial inner side, the seal 82 is defined by an undercut or groove 84. The undercut 84 forms a hinge, such that the lip 82 can pivot with respect to the rest of the base 64. The lip 82 includes several trapezoidal pumping cavities 86. (FIG. 4) The pumping cavities, which are shown to be generally trapezoidal in shape are similar to a pumping cavity shown and described in U.S. Pat. No. 4,770,548 to D. L. Otto, and which is incorporated herein by reference. The pumping mechanism, however, is not limited to this shape, and other shapes can be used depending on the application.

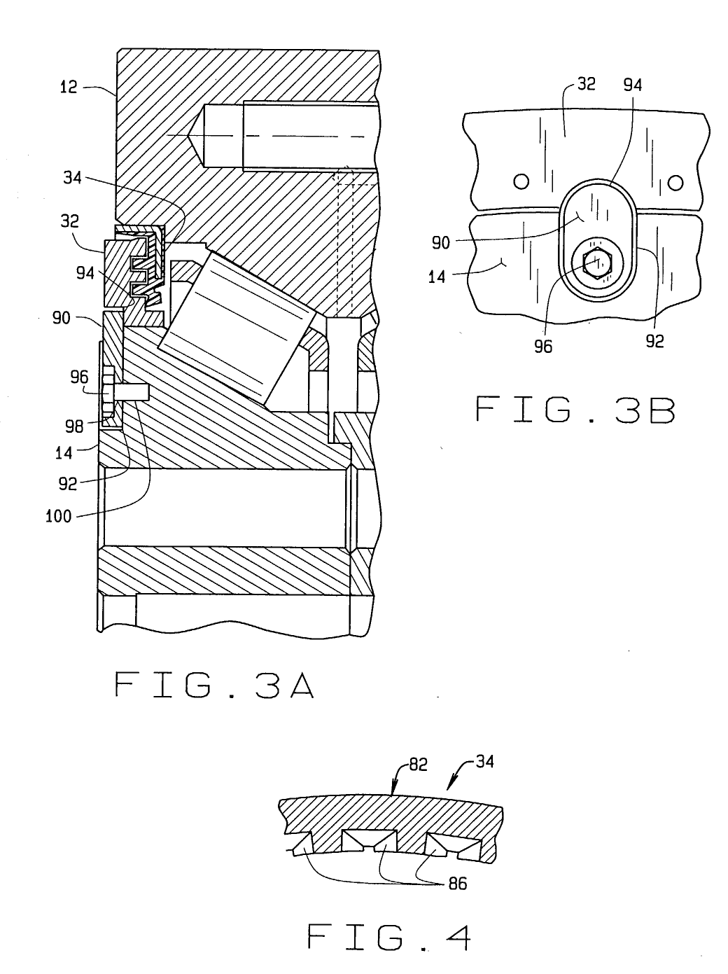

The first and second labyrinth elements 34 and 32 are press fit into their respective races, and abut the shoulders of the races to ensure squareness and to minimize runout of the sealing surfaces. Additionally, the second labyrinth element 32 is clamped against the abutment shoulder 26 by means of a number of clamping plates 90 (FIGS. 3A,B) which extend from a trough 92 in the inner race 14 to an aligned trough 94 in the second labyrinth element 32. Fasteners 96 (such as bolts or screws) extend through openings 98 of the plate 90 into threaded openings 100 in the cone 14. The clamping plate 90, when fixed to the inner race or cone 14 by the fasteners 96, ensures that the second labyrinth element 32 will remain seated against the inner race abutment shoulder 26 and that the second labyrinth element 32 will not rotate relative to the inner race 14. Should the seal need to be removed from the bearing in the field, the clamping plates 90 would be removed and the threaded holes 54 in the second labyrinth element 32 could be used to pull the ring off the cone rib outer diameter 24. As seen in FIGS. 1 and 2, the second labyrinth element is an axial outer element, and the first labyrinth element is an axial inner element, with the second labyrinth element overlying at least a part of the first labyrinth element. Hence, the use of the clamp 90 to hold the second labyrinth element in place will also hold the first labyrinth element in place. It will be appreciated that other clamping arrangements can be used to securely fix the labyrinth elements in place. For example, the second labyrinth element (or both labyrinth elements) could be provided with flanges which extend over the axial face of the bearing assembly, and fasteners could extend through the flange(s) into the axial face of the bearing assembly.

The ribs 51 and 78 and the grooves or channels 50 and 80 of the labyrinth elements 32 and 34 form continuous concentric circles, and are positioned, such that the ribs of one labyrinth element are received in the channels of the other labyrinth element, as seen in FIG. 2 when the seal 30 is installed on the bearing 10. The channels and ribs are sized (both in length and width) such that there is a radial clearance between the two labyrinth elements 32 and 34. This clearance forms a labyrinth path 88 between the labyrinth elements 32 and 34. The seal lip 82, as seen, comes to a narrow end 82a which forms an interference fit with the axial inner surface 42 of the second labyrinth element 32. There can be small amounts of clearance in this interference fit, such as might occur from wear or due to tolerance variations. As seen, the labyrinth path 88 extends generally radially between axial inner surface of the second labyrinth element 32 and axial outer surface of the first labyrinth element 34. However, it will be appreciated that the ribs and channels which form the labyrinth path could be formed on the radial surfaces of the labyrinth elements 32 and 34, such that the path 88 extends axially (as opposed to radially).

The axial inner surface 72 of the first labyrinth element 34 and the radial inner surface 38 of the second labyrinth element 32 form static seals with the outer and inner races, respectfully, and thus substantially prevent the ingress of contaminants into the bearing along the radial inner and outer surfaces of the outer and inner races 12 and 14, respectively. The sealing lip 82, on the other hand, by engaging the second labyrinth element 32, forms a dynamic fluid barrier between the two labyrinth elements 32 and 34, which closes the radial inner end of the labyrinth path 88, to prevent contaminants from entering the bearing through the path 88. The flexible hinge formed by the groove 84 enables the lip 82 to accommodate variability of relative axial positioning of the first and second labyrinth elements 34 and 32. Over time, the sealing lip 82 will wear to provide a small axial clearance against the second labyrinth element 32 under normal operating conditions. However, during regreasing, the increase in internal pressure will cause the lip 82 to flex axially outwardly and to seal against the axially inner surface 51 of the second labyrinth element 32, thereby preventing loss of lubricant through the labyrinth path 88.

As noted, the lip 82 flexes along its hinge groove 84 under pressure to form a seal against the second labyrinth element 32. The case 60 of the first labyrinth element 34 is made of metal and rigidizes the first labyrinth element 34. The radially extending leg 60b of the case 60 is shown to extend past the outermost radial rib 78 to a point at the approximate center of the channel 80. This length provides sufficient rigidity to the first labyrinth element 34 such that the innermost radial rib 78 will not flex substantially when the sealing lip 82 flexes or moves under pressure from the lubricant within the bearing. Thus, there will substantially always be a clearance between the first and second labyrinth elements 34 and 32 along the labyrinth path 88; the ribs and channels of the labyrinth elements 32 and 34 will not contact each other; and there will essentially be only one point of contact between the labyrinth elements—namely, at the tip 82a of the sealing lip 82. Preferably, as noted above, this contact occurs only during bearing regressing. During normal operating conditions, preferably there is a small clearance between the sealing lip 82 and the axial inner surface 51 of the second labyrinth element 32. Hence, frictional engagement between the labyrinth elements is substantially reduced.

During operation, the seal lip 82 substantially closes the labyrinth path 88 to substantially prevent lubricant from passing through the path 88 and to substantially prevent contaminants from entering the bearing 10 through the path 88. The labyrinth path 88 opens into the space between the sloped surfaces 52 and 76a of the second and first labyrinth elements 32 and 34. The sloped surfaces 52 and 76a on the radial outer surface of the second labyrinth element 32 and the wall 76 of the first labyrinth element 34 are generally opposite each other, and reduce the possibility of water or other contaminants from entering the bearing through the labyrinth path 88. The slope of these surfaces generates a centrifugal force which forces contaminants axially away from the opening to the labyrinth path.

A second embodiment of the seal is shown in FIG. 5. The seal 30′ of FIG. 5 is substantially similar to the seal 30 of FIG. 2. It includes the second labyrinth element 32 which is identical to the second labyrinth element 32 described above in conjunction with FIGS. 1-4. The first labyrinth element 34′ is substantially similar to the first labyrinth element 34 of FIG. 2. It varies from the first labyrinth element 34 only in the manner in which the sealing lip 82′ is formed. As described above, the seal lip 82 (FIG. 2) flexes axially to seal against the axial inner surface 51 of the second labyrinth element 32. The sealing lip 82′, on the other hand, is configured to seal against the radial outer wall 47 of the second labyrinth element 32, and hence, seals against a radial surface (rather than an axial surface) of the second labyrinth element 32. The first labyrinth element 34′ includes a groove 84′ (shown to be triangular in shape) which allows the lip 82′ to flex. Although the lip 82′ seals against a radial surface, rather than an axial surface, of the second labyrinth element 32, the operation of the lip 82′ is substantially the same as described above in conjunction with the lip 82. Preferably, there is a small clearance between the seal lip 82′ and the radial outer wall 47. However, contact between these parts is acceptable.

As various changes could be made in the above constructions without departing from the scope of the invention, it is intended that all matter contained in the above description or shown in the accompanying drawings shall be interpreted as illustrative and not in a limiting sense. Although the labyrinth elements 32 and 34 are shown to include two grooves in the second labyrinth element 32 and two ribs in the first labyrinth element 34, the seal could include only one groove in one of the labyrinth elements and only one rib in the other of the labyrinth elements. Alternatively, each of the labyrinth elements could include two or more ribs and two or more grooves. These examples are merely illustrative.

1. A seal for sealing a gap between two parts; the seal comprising a first labyrinth element and a second labyrinth element which are matable together to form a labyrinth path;
said first and second labyrinth elements having opposed surfaces; one of said labyrinth elements including at least one rib and the other of said labyrinth elements having at least one channel; said at least one rib and said at least one channel being formed on said opposed surfaces such that said at least one rib is received in said at least one channel; said ribs and said channels being sized and shaped to interfit with each other to define labyrinth path between said first and second labyrinth elements; and
a seal lip on one of said first and second labyrinth elements; said seal lip being sized and shaped to seal against the other of said first and second labyrinth elements at an inner end of said labyrinth path; said seal lip forming a dynamic fluid barrier between said first and second labyrinth elements.

2. The seal of claim 1 wherein said labyrinth path extends generally radially.

3. The seal of claim 1 wherein said seal includes at least one pumping cavity on said seal lip.

4. The seal of claim 1 wherein said seal lip is pivotal relative to its respective labyrinth element, said labyrinth element including a hinge about which said seal lip flexes.

5. The seal of claim 1 wherein one of said seal lip seals against an axial surface.

6. The seal of claim 5 wherein there is an clearance between said seal lip and said axial surface.

7. The seal of claim 1 wherein said seal lip seals against a radial surface.

8. The seal of claim 7 wherein there is an clearance between said seal lip and said radial surface.

9. The seal of claim 1 wherein said seal lip is on said first labyrinth element.

10. The seal of claim 1 wherein said first labyrinth element has a circumferential wall having a radially inner surface; said radially inner surface of said first labyrinth element wall being at least partially sloped such that an axial outer end of said sloped surface has a greater diameter than an axial inner end of said sloped surface; and
said second labyrinth element having a radial outer wall; and said radial outer surface of said second labyrinth element being at least partially sloped such that an axial outer end of said sloped surface has a diameter smaller than a diameter of an inner axial end of said sloped surface.

11. The seal of claim 10 wherein said sloped surfaces of said first and second labyrinth elements are opposite each other and face each other.

12. In an assembly comprising a first outer part and a second inner part; said second part being received within said first part; said first and second parts being rotatable relative to each other; the improvement comprising a seal between said first and second parts; the seal comprising a first labyrinth element received on an inner diameter of said first part and a second labyrinth element received on an outer diameter of said second part;
said labyrinth elements having opposed surfaces, said seal including at least one channel and at least one rib formed on said opposed surfaces of said labyrinth elements; said at least one rib of said first labyrinth element being received in said at least one channel of said second labyrinth element; said ribs and said channels being sized and shaped to interfit with each other to define labyrinth path between said labyrinth elements; and
said first labyrinth element having a radial inner surface which is at least partially sloped such that an axial outer end of said sloped surface has a greater diameter than an axial inner end of said sloped surface; and said second labyrinth element having a radial outer surface which is at least partially sloped such that an axial outer end of said sloped surface has a diameter smaller than a diameter of an inner axial end of said sloped surface.

13. The improvement of claim 12 wherein said sloped surfaces of said first and second labyrinth elements are opposite each other and face each other.

14. The improvement of claim 12 including a flexible seal lip on one of said first and second labyrinth elements, said seal lip being sized and shaped to seal against a surface of the opposed labyrinth element.

15. A bearing assembly comprising an inner race, an outer race, a plurality of rolling elements positioned between said inner and outer races, and a seal which seals a gap between said inner and outer races to substantially prevent lubricant from escaping from said bearing assembly; said seal comprising:
a first labyrinth element and a second labyrinth element; said first and second labyrinth elements having opposed surfaces which face each other, at least one rib formed in one of said opposed surfaces and at least one channel formed in the other of said opposed surfaces, said at least one rib and at least one channel being sized and shaped to interfit with each other to form a labyrinth path between said first and second labyrinth elements;
a seal lip on one of said first and second labyrinth elements, said seal lip being positioned to seal against a surface of the other of said first and second labyrinth elements.

16. The bearing assembly of claim 15 wherein said labyrinth path is formed on axial surfaces of said labyrinth elements, where by said labyrinth path extends generally radially.

17. The bearing assembly of claim 15 wherein said seal lip engages one of an axial extending surface and a radial extending surface on the opposed labyrinth element.

18. The bearing assembly of claim 15 wherein said first labyrinth element includes a radial outer wall having an inner surface; said inner surface of said radial outer wall being at least partially sloped; said second labyrinth element including a radial outer surface; said radial outer surface of said second labyrinth element being at least partially sloped.

19. The bearing assembly of claim 18 wherein said sloped portions of said surfaces of said first and second labyrinth elements are opposite each other.

20. The bearing assembly of claim 19 wherein said sloped portions of said surfaces slope away from each other, whereby the distance between said radially inner surface of said first labyrinth element and said radially outer surface of said second labyrinth elements increases axially outwardly.

21. The bearing assembly of claim 15 wherein said first labyrinth element is received on a radial inner surface of said outer race and said second labyrinth element is received on an outer radial surface of said inner race; said first and second labyrinth elements forming static seals with said outer and inner races, respectively; and said seal lip forming a dynamic fluid barrier between said first and second labyrinth elements.

22. The bearing assembly of claim 15 wherein said seal lip is pivotally connected to said first labyrinth element.

23. The bearing assembly of claim 15 wherein at least one of said first and second labyrinth elements are fixed to their respective race.

24. The bearing assembly of claim 23 including a plate which extends from an axial end of said second labyrinth element to an axial end of said inner race and a fastener which extends through said plate into said axial face of said inner race; said plate fixedly securing said second labyrinth element to said inner race.
